(19) United States
(12) Patent Application Publication
(10) Pub. No.: US 2024/0309229 A1
(43) Pub. Date: Sep. 19, 2024

(54) COATING COMPOSITION AND ARTICLE

(71) Applicant: CANON KABUSHIKI KAISHA, Tokyo (JP)

(72) Inventors: SHUHEI YAMAMOTO, Tokyo (JP); TOMONARI NAKAYAMA, Tokyo (JP); YO WATANABE, Tokyo (JP)

(21) Appl. No.: 18/676,194

(22) Filed: May 28, 2024

Related U.S. Application Data
(63) Continuation of application No. PCT/JP2022/043970, filed on Nov. 29, 2022.

(30) Foreign Application Priority Data
Nov. 29, 2021 (JP) 2021-193331
Nov. 28, 2022 (JP) 2022-189345

(51) Int. Cl. C09D 7/61; C09D 1/04; C09D 5/14; C09D 7/20; C09D 7/40; C09D 183/02

(52) U.S. Cl. CPC C09D 7/61; C09D 1/04; C09D 5/14; C09D 7/20; C09D 7/67; C09D 7/68; C09D 183/02

(57) ABSTRACT

A coating composition includes an inorganic compound particle, a binder component, a solvent, and an antibacterial/antiviral agent. The content of the binder component is 1 part by mass or more and 25 parts by mass or less based on 100 parts by mass of the inorganic compound particle.

### CROSS-REFERENCE TO RELATED APPLICATIONS

This application is a Continuation of International Patent Application No. PCT/JP2022/043970, filed Nov. 29, 2022, which claims the benefit of Japanese Patent Application No. 2021-193331, filed Nov. 29, 2021 and Japanese Patent Application No. 2022-189345, filed Nov. 28, 2022, both of which are hereby incorporated by reference herein in their entirety.

### TECHNICAL FIELD

The present invention relates to a coating composition for forming a layer having antibacterial/antiviral properties and an article including a layer having antibacterial/antiviral properties.

### BACKGROUND ART

As hygiene considerations and virus infection measures, coating for imparting antibacterial/antiviral properties to various articles has been developed.

For example, in water section equipment such as toilets, bathrooms, and washstands, mold spores and yeast floating in the air attach to water droplets and grow and multiply using organic dirt as nutrients to tend to generate blackening and red spots. Such water section equipment is primarily required to have antibacterial properties.

In addition, in articles that may be touched by an unspecified large number of people, such as exterior parts of medical equipment, displays with touch panels, and handrails for stairs and trains, there is a high risk that viruses and bacteria will adhere to them and may multiply and affect the human bodies. Such articles are required to have antibacterial properties and antiviral properties.

PTL 1 discloses a hydrophilic coating agent as a mixture of 5 to 100 nm nano silica, a silicate oligomer, a low-temperature firing glass powder, carboxymethylcellulose sodium, and a synthetic detergent. A coating film obtained using this hydrophilic coating agent can be imparted with hydrophilicity, antifouling property, antibacterial property, water resistance, and weather resistance.

PTL 2 discloses technique for forming a coating film with antibacterial properties by applying a liquid composition containing a binder component mainly composed of a silicon oxide matrix raw material component and an antibacterial active material such as silver or copper to the film.

The films having antibacterial properties described in PTL 1 and PTL 2 are assumed from the components of the coating liquids that the films do not have a porous structure. In such a dense film not having a porous structure, since antibacterial components are difficult to move in the film, the antibacterial effect cannot be expressed when the antibacterial components on the film surface disappear, and it is impossible to maintain the antibacterial effect over a long period of time.

### CITATION LIST

### Patent Literature

PTL 1 Japanese Patent Laid-Open No. 2020-29549

PTL 2 International Publication No. WO 2015/166858

### SUMMARY OF INVENTION

Objects of the present invention are to provide a part that can maintain antibacterial/antiviral action over a long period of time and a coating composition that can provide such a part.

The coating composition according to the present invention contains an inorganic compound particle, a binder component, and an antibacterial/antiviral agent, wherein the content of the binder component is 1 part by mass or more and 25 parts by mass or less based on 100 parts by mass of the inorganic compound particle.

The article according to the present invention includes a base material and a porous layer on at least one main surface of the base material, wherein the porous layer contains a plurality of inorganic compound particles bound to each other by a binder and an antibacterial/antiviral agent.

Further features of the present invention will become apparent from the following description of exemplary embodiments with reference to the attached drawings.

### BRIEF DESCRIPTION OF DRAWINGS

FIG. 1A is a diagram illustrating a base material before coating with a coating composition.

FIG. 1B is a partially enlarged schematic diagram of an article according to the present invention.

FIG. 2 is a schematic diagram for explaining an example of the coating composition.

### DESCRIPTION OF EMBODIMENTS

Embodiments of the present invention will be described with reference to the drawings, but the present invention is not limited to the specific examples shown below and can be changed within the technical idea of the present invention. In the explanation and drawings below, components common to multiple drawings are designated by the same reference numerals. Explanation may be omitted for components with the same reference numerals.

### Configuration of Article

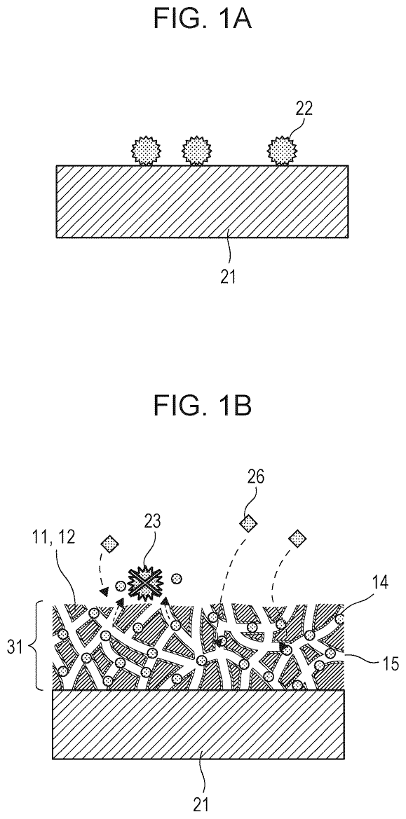

FIG. 1A is a diagram illustrating a base material 21 before coating with a coating composition, and FIG. 1B is the base material 21 coated with a coating composition according to the present invention and is a partially enlarged schematic diagram of an article according to the present invention. Contaminants 22 such as mold, bacteria, and viruses in the environment are present on the surface of the base material (substrate) 21 before coating with a coating composition (FIG. 1A).

The coating composition according to the present invention contains an inorganic compound particle, a binder component, an antibacterial/antiviral agent, and a solvent. By application of the coating composition to the surface of the base material 21, the antibacterial/antiviral agent dispersed or dissolved in the solvent acts on the contaminants 22 present on the surface of the base material 21 to suppress their multiplication or destroy or inactivate them. The coating composition applied onto the base material 21 dries and thereby functions as a layer 31 expressing an antibacterial/antiviral effect.

The material of the base material 21 is not particularly limited and may be stainless steel, ceramics, glass, or a resin. The base material 21 may have any shape that can be coated with the coating composition and can take various shapes with a flat surface, a curved surface, an uneven surface, and a combination thereof. Concrete examples of the base material 21 include a touch panel display, a doorknob, a hanging strap, a handrail, water section equipment such as a sink and a toilet, window glass, and a car body.

Alternatively, a method of forming a layer by coating a coating composition on a film or plate of a resin, glass, a metal, or the like and then attaching it to a surface of the above-mentioned article to impart antibacterial/antiviral properties to a part may be used.

When the solvent contained in the coating composition applied to the base material 21 volatilizes and dries out, a plurality of inorganic compound particles 11 are bound to each other by the hardened product (binder) 12 of the binder component to form a layer (porous layer) 31 having a porous structure. As shown in FIG. 1B, the pores 15 included in the layer 31 are those formed from spaces between a plurality of inorganic compound particles 11 that are interconnected and communicated with each other. The antibacterial/antiviral agent 14 adheres to the wall surfaces of the pores 15 and is held inside the layer 31.

Since the inorganic compound particles constituting the layer 31 have hydrophilicity, the surfaces of the pores 15 become hydrophilic, and moisture 26 in the air can be absorbed inside the pores 15. Since the absorbed moisture 26 constantly supplies the antibacterial/antiviral ingredient originated from the antibacterial/antiviral agent 14 adhering to the wall surfaces of the pores 15 to the surface of the film, the layer 31 can maintain the antibacterial/antiviral properties over a long period of time.

Since the surface of the layer 31 is also hydrophilic due to the hydrophilicity of the inorganic compound particles, contaminants 22 can be easily removed from the surface of the layer 31 by washing with water or wiping off with a non-woven cloth containing water or alcohol. In wiping off, even if the antibacterial/antiviral ingredient present on the surface of the layer 31 is decreased together with contaminants 22, the antibacterial/antiviral ingredient is supplied to the surface of the layer 31 from the antibacterial/antiviral agent 14 held inside the layer 31 through the pores 15. Consequently, the antibacterial/antiviral properties can be maintained over a long period of time.

The antibacterial/antiviral ingredient varies depending on the antibacterial/antiviral agent used. The antibacterial/antiviral agent itself may be the antibacterial/antiviral ingredient, or a material generated from the antibacterial/antiviral agent may become the antibacterial/antiviral ingredient. For example, in an organic antibacterial/antiviral agent that will be described later, the antibacterial/antiviral agent itself functions as an antibacterial/antiviral ingredient. In an inorganic antibacterial/antiviral agent, the agent generates active oxygen (such as hydroxy radicals) by a reaction with water absorbed in the pores 15, and this active oxygen functions as an antibacterial/antiviral ingredient.

In order to realize a layer 31 having a strength that can withstand use for a certain period of time and excellent antibacterial/antiviral properties, it is preferable that the layer 31 does not include an aperture having a diameter exceeding half the film thickness in a cross-section in the film thickness direction. The diameter of the aperture is the average of the equivalent circle diameters of a plurality of regions corresponding to apertures observed using a scanning microscope in a cross section of the layer 31 in the film thickness direction. Cross sections of the layer 31 in the film thickness direction are cut out from 5 locations and are enlarged using a scanning microscope. The observation image observed by a scanning electron microscope is divided into a region corresponding to the particles, binder, and antibacterial agent and a region corresponding to apertures by image processing. Equivalent circle diameters are calculated from the areas of the regions corresponding to the respective apertures, and the average thereof is measured as the diameter of aperture. As the image processing, commercially available image processing such as image Pro PLUS (manufactured by Media Cybernetics, Inc.) can be used. In a predetermined image region, the contrast is appropriately adjusted as needed, the equivalent circle diameters of apertures are measured by commercially available particle measurement software, and average thereof can be determined.

Considering the preferred thickness of the layer 31, a state in which the layer 31 does not contain a large aperture with a diameter exceeding 100 nm is preferable.

The thickness of the layer 31 is not particularly limited but is preferably 0.02 μm or more and 10 μm or less and more preferably 0.04 μm or more and 5 μm or less.

When the film thickness is smaller than 0.02 μm, the amount of the antibacterial/antiviral agent 14 may be insufficient, and antibacterial/antiviral properties may not be sufficiently obtained. If the blending amount of the antibacterial/antiviral agent 14 is increased as a countermeasure, the coating film has a decreased strength and is worn out due to, for example, contact with water or people, and the decrease in the film thickness causes a risk of an insufficient amount of the antibacterial/antiviral agent 14. When the film thickness exceeds 10 μm, film cracking tends to occur after drying of the coating composition, and the coating film tends to peel off from the surface of the base material 21.

### Antibacterial/Antiviral Agent

The antibacterial/antiviral agent is not particularly limited, and known agents can be used, and it may be either inorganic or organic.

Organic antibacterial/antiviral agents tend to bind less easily to the inorganic compound particles 11 than inorganic antibacterial/antiviral agents and tend to easily move in the layer 31. Accordingly, although the duration of the organic antibacterial/antiviral agents may be short compared to inorganic antibacterial/antiviral agents, but a high antibacterial effect is obtained. When an organic antibacterial/antiviral agent is used, a high effect can be maintained by applying the coating composition again. Before the coating composition is applied, contaminants 22 adhering to the base material 21 may be removed as needed.

Examples of the organic antibacterial/antiviral agent include monoterpene derivatives represented by C₁₀H₁₄O such as thymol and isopropylmethylphenol, paraben, thiabendazole, a quaternary ammonium salt, a phenol ether derivative, an imidazole derivative, a carbamic acid ester derivative, a sulfone derivative, an organic nitrogen compound, an N-haloalkylthio compound, an organic halide, an anilide derivative, a pyrrole derivative, a pyridine compound, a triazine compound, a benzisothiazoline compound, an isothiazoline compound, and an alcohol, and at least one selected from the group consisting of these agents can be preferably used. The organic antibacterial/antiviral agent 14 contained in the coating composition or its layer can be specified by elemental analysis, organic separation and quantitative analysis using ion exclusion chromatography, or the like.

Some of the organic antibacterial/antiviral agents have solubility in alcohol and water, but in members that often come into contact with water, it is best to use one that has low solubility in water. An organic antibacterial/antiviral agent having low solubility in water does not flow out in a large quantity even if the layer 31 is exposed to flowing water and is likely to remain inside the layer 31, and the antibacterial/antiviral properties can be kept.

As the inorganic antibacterial/antiviral agent, at least one compound selected from the group consisting of copper, silver, zinc, and nickel can be preferably used. As the inorganic antibacterial/antiviral agent, for example, a material described in Japanese Patent Laid-Open No. 6-271472, Japanese Patent Laid-Open No. 2012-210557, Japanese Patent Laid-Open No. 2012-229424, PCT Japanese Translation Patent Publication No. 2014-519504, Japanese Patent Laid-Open No. 2014-122457, International Publication No. WO 2014/132606, International Publication No. WO 2015/166858, International Publication No. WO 2016/042913, Japanese Patent Laid-Open No. 2020-40935, or Japanese Patent Laid-Open No. 2020-12214 can be used. Here, the disclosure content of these documents is hereby incorporated and made into part of the disclosure content of this specification. The inorganic antibacterial/antiviral agent 14 contained in the coating composition or its layer can be specified by elemental analysis, quantitative analysis by ion chromatography, or the like.

The amount of the antibacterial/antiviral agent contained in the layer 31 is not particularly restricted and is preferably 0.01 mass % or more and 50 mass % or less, more preferably 0.1 mass % or more and 40 mass % or less, further preferably 0.5 mass % or more and 30 mass % or less, and particularly preferably 1 mass % or more and 30 mass % or less. An amount less than 0.01 mass % tends not to provide sufficient antibacterial properties, and an amount higher than 50 mass % weakens the film strength and thereby tends to easily make the film disappear when it is exposed to flowing water or comes into contact with people. The amount of the antibacterial/antiviral agent contained in the layer 31 can be calculated by fluorescent X-ray analysis.

Antibacterial/antiviral agents may be used alone or in combination of two or more. When two or more antibacterial/antiviral agents are used, the total content is preferably within the above-mentioned range.

The average particle diameter of the antibacterial/antiviral agent 14 is preferably 1 nm or more and 200 nm or less and more preferably 5 nm or more and 20 nm or less. In a particle having an average particle diameter of 1 nm or less or when the average particle diameter is less than 5 nm, the antibacterial/antiviral agent inside the layer 31 tends to flow out when exposed to flowing water, and the antibacterial properties are not kept. When the average particle diameter is larger than 200 nm, the surface area per unit volume of the antibacterial/antiviral agent 14 inside the layer 31 decreases, which makes it difficult to supply the antibacterial/antiviral ingredient to the layer surface through the pores, resulting in insufficiency of the antibacterial/antiviral properties. The average particle diameter of the antibacterial/antiviral agent 14 inside the layer 31 can be measured by observing a cross section of the layer 31 in the film thickness direction with a transmission electron microscope, and the average Ferret diameter calculated from an observation image is used.

### Inorganic Compound Particle

As the inorganic compound particle contained in the coating composition, silicon oxide, zirconium oxide, magnesium oxide, aluminum oxide, and the like can be used, and from the viewpoint of excellent hydrophilicity, a silicon oxide particle is particularly preferable. As the inorganic compound particles 11, particles with various shapes such as a true sphere, a cocoon shape, a barrel shape, a disk shape, a rod shape, a needle shape, a square, a chain shape, and a hollow shape can be used. A single type of the inorganic compound particles may be used, or a combination of multiple types of the inorganic compound particles may be used. The multiple types referred to here may be a combination of particles with the same composition but different shapes or a combination of particles having the same shape but different compositions.

The average particle diameter of the inorganic compound particles 11 not connecting multiple particles of real sphere, cocoon shape, barrel shape, hollow shape, or the like is preferably 10 nm or more and 1000 nm or less. When the average particle diameter of the inorganic compound particles 11 is 10 nm or less, the pores 15 that are formed in the layer 31 become too small, and the antibacterial/antiviral ingredient is hard to move. When the average particle diameter exceeds 1000 nm, the dispersibility in the solvent decreases, and it is difficult to make the layer 31 uniform. The average particle diameter of particles here is the average Ferret diameter. The average Ferret diameter can be measured by image processing of one observed by a transmission electron microscope. As the image processing, commercially available image processing such as image Pro PLUS (manufactured by Media Cybernetics, Inc.) can be used. In a predetermined image region, the contrast is appropriately adjusted as needed, and the Ferret diameter of each particle can be determined.

In a chain-shaped particle, the average particle diameter of the primary particles constituting the chain-shaped particle is preferably 8 nm or more and 20 nm or less. When the average particle diameter of the primary particles is less than 8 nm, the pores that are formed in the layer 31 become too small. When the average exceeds 20 nm, the dispersion in a solvent becomes unstable, which causes a concern of deterioration in the coating properties such that uniform coating cannot be achieved. The average particle diameter of the primary particles constituting chain-shaped particles also can be measured as an average Ferret diameter by image processing of an observation image observed by a transmission electron microscope.

The inorganic compound particles 11 contained in the coating composition of the present invention preferably have a surface condition that allows the particles to bind to each other via the inorganic binder when layered. Silicon oxide particles which are particularly preferable as the inorganic compound particles originally have a large number of silanol (Si—OH) groups on the surface. It is possible to further increase the number of silanol groups on the surface by a method of mixing with a silica binder described later to provide a surface condition that makes it easier for silicon oxide particles to bind to each other. When the coating composition is coated and dried to make a condition in which a plurality of particles are in contact with each other, the silicon oxide particles bind to each other, which can increase the strength of the film.

The silicon oxide particle 11 is a particle whose main component is silicon oxide, but part of the Si element may be replaced by another element such as Al, Ti, Zn, Zr, or B, or an organic group may be bound to a Si element. In such a case, among elements excluding oxygen and hydrogen, the content of elements other than Si is preferably 5 at % or less. When the content of elements other than Si exceeds 5 at %, the number of the Si—OH group on the particle surface decreases, resulting in a risk of losing the hydrophilicity.

### Binder

The binder for binding between inorganic compound particles is not particularly limited, and either an organic binder or an inorganic binder may be used, or a combination thereof may be used. As the organic binder, an acrylic resin, an epoxy resin, a vinyl resin, a melanin resin, or the like can be used. As the inorganic binder, a silicon oxide compound or an aluminum oxide compound can be used. In particular, a silicon oxide compound is preferable. When the binder is an inorganic compound material as in the inorganic compound particle, the binding strength between particles is increased, and a porous layer that is unlikely to be deteriorated by the usage environment can be realized. A preferable example of the silicon oxide compound is a hardened product of a silicon oxide oligomer obtained by hydrolyzing and condensing silicic acid ester.

The binder amount in the porous layer is desirably 1 part by mass or more and 25 parts by mass or less based on 100 parts by mass of the inorganic compound particle contained in the porous layer and is more desirably 1 part by mass or more and 15 parts by mass or less. When the binder amount is less than 1 part by mass, the strength of the film tends to decrease, and when the amount exceeds 20 parts by mass, the apertures contained in the layer 31 may become insufficient for the antibacterial/antiviral ingredient to move.

### Coating Composition

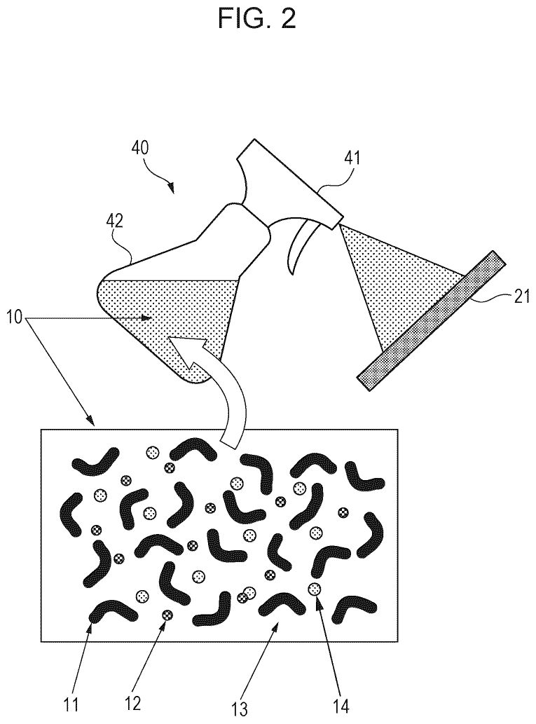

The coating composition 10 according to the present invention includes an inorganic compound particle 11, a binder component 12, a solvent 13, and an antibacterial/antiviral agent 14, as shown in FIG. 2.

### Antibacterial/Antiviral Agent

The antibacterial/antiviral agent 14 contained in the coating composition 10 is as described above.

The antibacterial/antiviral agent 14 may be present in the coating composition 10 in a state of binding to the surface of the inorganic compound particle 11 or binder component, but is preferably at least partially dispersed or dissolved in the coating composition 10. When the coating composition 10 is formed into a film, since the antibacterial/antiviral agent 14 in the layer tends to easily move, a high sterilization effect or virus deactivation effect can be easily obtained.

The average particle diameter of the antibacterial/antiviral agent 14 is preferably 1 nm or more and 200 nm or less and more preferably 1 nm or more and 20 nm or less. When the average particle diameter is smaller than 1 nm, it tends to be difficult to physically disperse the antibacterial/antiviral agent 14 in a solvent. When the average particle diameter is larger than 200 nm, the antibacterial/antiviral agent 14 aggregates with each other or with the inorganic compound particle or binder component 12 to tend to become difficult to be stably dispersed.

The size of the antibacterial/antiviral agent 14 can be adjusted by a known method such as dry grinding and wet grinding. In the dry grinding, for example, a mortar, a ball mill, a bead mill, a jet mill, a hammer mill, a pin mill, a rotary mill, a vibration mill, or a planetary mill is used as appropriate. In wet grinding, a ball mill, a bead mill, a jet mill, a high-speed rotary pulverizer, an ultrasonic homogenizer, a high-pressure homogenizer, or the like can be used as appropriate. For example, in a bead mill, the particle size can be adjusted by controlling the diameter, type, and the mixing amount of the beads as a media.

The amount of the antibacterial/antiviral agent contained in the coating composition 10 is not particularly limited and is preferably 0.01 parts by mass or more and 50 parts by mass or less based on 100 parts by mass of the total solid content of the composition and is more preferably 0.1 part by mass or more and 40 parts by mass or less, further preferably 0.5 parts by mass or more and 30 parts by mass or less, and particularly preferably 1 part by mass or more and 30 parts by mass or less. When the content of the antibacterial/antiviral agent contained in the coating composition 10 is less than 0.01 parts by mass, the antibacterial properties of the resulting layer 31 tend to be insufficient. When the content is higher than 50 parts by mass, the film strength of the layer 31 is low, and the film tends to easily disappear when it is exposed to flowing water or comes into contact with people. The content of the antibacterial agent in the coating composition is preferably 0.0001 parts by mass or more and 20 parts by mass or less based on 100 parts by mass of the total solid content of the coating composition and is more preferably 0.001 parts by mass or more and 10 parts by mass or less. When the content is less than 0.0001 parts by mass, the layer 31 cannot obtain sufficient antibacterial properties, and when the content is higher than 20 parts by mass, the dispersion stability of the coating composition tends to deteriorate.

Antibacterial/antiviral agents may be used alone or in combination of two or more. When two or more antibacterial/antiviral agents are used, the total content is preferably within the above-mentioned range.

### Inorganic Compound Particle

The inorganic compound particles 11 contained in the coating composition 10 are as described above. The size of the apertures included in the layer 31 formed from the coating composition 10 changes by the dispersion state of the inorganic compound particles in the coating composition and by the dispersion state of the inorganic compound particles during from the application of the coating composition to the base material 21 until drying. When the inorganic compound particles are aggregated, the diameter of the apertures becomes larger, and when the particles are individually dispersed, the diameter of the apertures becomes smaller. By controlling the particles to repel each other by, for example, surface treatment of the inorganic compound particles or addition of a dispersant to the coating composition, a state in which individual inorganic compound particles are dispersed can be realized.

The content of the inorganic compound particles 11 in the coating composition 10 is preferably 2 parts by mass or more and 10 parts by mass or less based on 100 parts by mass of the total solid content of the coating composition. When the content of the inorganic compound particles is less than 2 parts by mass, it is difficult to form a continuous porous layer, and when the content exceeds 10 parts by mass, the viscosity of the coating composition 10 increases, resulting in a decrease of the coating properties.

### Solvent

The solvent that can be used in the coating composition 10 may be any solvent that does not cause precipitation of the antibacterial/antiviral agent 14 and the inorganic compound particles 11 and does not cause a sharp increase in the viscosity of the coating composition 10 due to aggregation of the inorganic compound particles 11, and examples thereof include water; monovalent alcohols such as methanol, ethanol, 1-propanol, 2-propanol, 1-butanol, 2-butanol, 2-methylpropanol, 1-pentanol, 2-pentanol, cyclopentanol, 2-methylbutanol, 3-methylbutanol, 1-hexanol, 2-hexanol, 3-hexanol, 4-methyl-2-pentanol, 2-methyl-1-pentanol, 2-ethylbutanol, 2,4-dimethyl-3-pentanol, 3-ethylbutanol, 1-heptanol, 2-heptanol, 1-octanol, and 2-octanol; di- or higher valent alcohols such as ethylene glycol and triethylene glycol; ether alcohols such as methoxyethanol, ethoxyethanol, propoxyethanol, isopropoxyethanol, butoxyethanol, 1-methoxy-2-propanol, 1-ethoxy-2-propanol, and 1-propoxy-2-propanol; ethers such as dimethoxyethane, diglyme, tetrahydrofuran, dioxane, diisopropyl ether, dibutyl ether, and cyclopentyl methyl ether; esters such as ethyl formate, ethyl acetate, n-butyl acetate, methyl lactate, ethyl lactate, ethylene glycol monomethyl ether acetate, ethylene glycol monoethyl ether acetate, ethylene glycol monobutyl ether acetate, and propylene glycol monomethyl ether acetate; various aliphatic or alicyclic hydrocarbons such as n-hexane, n-octane, cyclohexane, cyclopentane, and cyclooctane; various aromatic hydrocarbons such as toluene, xylene, and ethylbenzene; various ketones such as acetone, methyl ethyl ketone, methyl isobutyl ketone, cyclopentanone, and cyclohexanone; various chlorinated hydrocarbons such as chloroform, methylene chloride, carbon tetrachloride, and tetrachloroethane; and aprotic polar solvents such as N-methylpyrrolidone, N,N-dimethylformamide, N,N-dimethylacetamide, and ethylene carbonate. A mixture of two or more of these solvents may be used.

From the viewpoint of the dispersibility and coating characteristics of the inorganic compound particle, 30% or more of the solvent contained in the coating composition 10 is preferably a water-soluble solvent having 4 to 6 carbon atoms and a hydroxy group. In particular, as the solvent, the coating composition 10 preferably contains at least one selected from the group consisting of ethoxyethanol, propoxyethanol, isopropoxyethanol, butoxyethanol, 1-methoxy-2-propanol, 1-ethoxy-2-propanol, 1-propoxy-2-propanol, and ethyl lactate.

### Binder Component

The binder component 12 contained in the coating composition 10 is a component that becomes a binder for binding inorganic compound particles 11 to each other when formed into a coating film. As the binder component of the present invention, an organic or inorganic binder can be used, but an inorganic binder is preferred because a hydrophilic layer 31 can be easily obtained. The inorganic binder component is preferably a silicon oxide oligomer obtained by hydrolyzing and condensing silicic acid ester. The silicon oxide oligomer hardens and functions as a binder for the silicon oxide compound, and a layer 31 that is porous but has a high mechanical strength can be formed.

In the present invention, the content of the binder component 12 is preferably 1 part by mass or more and 25 parts by mass or less based on 100 parts by mass of the inorganic compound particle and is more preferably 1 part by mass or more and 15 parts by mass or less. By being in such a condition, the film strength can be adjusted so that a film withstands use in environments where the film is exposed to flowing water or is touched by a large number of people for a certain period of time and has excellent repairability that can be peeled off by dusting and cleaning and can be easily reapplied. When the content of the binder component 12 is less than 1 part by mass based on the inorganic compound particles 11, the strength of the layer 31 tends to be insufficient. When the content of the binder component 12 is higher than 25 parts by mass based on the inorganic compound particles 11, the spaces between the inorganic compound particles are filled with the binder to reduce pores, which makes the antibacterial/antiviral ingredient difficult to move in the layer. As a result, the antibacterial properties tend to decrease in a short period of time.

### Another component

The coating composition 10 may contain an additive within a range that does not impair the original purpose. Examples of the additive are materials such as a dispersant, a surface treatment agent, a surfactant, an antistatic agent, an antioxidant, a thickener, a dye, an aroma chemical, and a deodorant. These additives may be used alone or in combination of two or more. However, one that does not decrease the antibacterial function by reaction with the antibacterial agent 14 is used.

The dispersant that is added to the coating composition 10 is preferably an acid. The addition of an acid modifies the surface of the inorganic compound particle 11 by an acidic group, and the inorganic compound particles 11 repel each other by the presence of the acidic group to be uniformly dispersed. As a result, it is possible to suppress the formation of large apertures in the formed layer 31. The pH value of the coating composition 10 when an acid is added as a dispersant is preferably 2 or more and 8 or less and more preferably 3 or more and 7 or less.

### Manufacturing Method of Coating Composition

The coating composition 10 may be prepared by adding an antibacterial agent and an inorganic compound particle to a solvent and mixing, dispersing, and dissolving them or by mixing a solution of an antibacterial/antiviral agent dispersed in a solvent and a dispersion of an inorganic compound particle dispersed in a solvent. The coating composition 10 obtained by separately dissolving or dispersing an antibacterial/antiviral agent and an inorganic compound particle in respective solvents and mixing them is preferred from the viewpoint of dispersion stability. Reversely, if there is no problem with dispersion stability, it is also possible to add an antibacterial/antiviral agent to a solvent in which an inorganic compound particle is dispersed or dissolved.

As long as an antibacterial/antiviral agent and an inorganic compound particle are dissolved or dispersed in a solvent, the coating composition 10 can be produced by mixing, dispersing, or dissolving raw materials by a known method. More easily, all constituent materials are put in one container and may be mixed, dispersed, or dissolved by stirring with a propeller. The coating composition 10 can be produced by mixing, dispersing, or dissolving by a known dispersion method with an ultrasonic stirrer, a mixer, a homogenizer, a planetary rotation device, a collision dispersing device, a disk mill, a sand mill, a bead mill, a ball mill, or the like.

### Coating Method of Coating Composition

### Spray Method

As the coating method of the coating composition 10, a spray method is particularly preferred because it is simple and less uneven coating. As shown in FIG. 2, the spray method is preferable because the coating composition 10 can be easily applied when needed by handling it as a spray coating material 40 composed of a spray container including an ejection part 41 and a material storage part 42 filled with the coating composition 10. It is also preferable that the surface of the base material is cleaned with a neutral detergent or alcohol or polished with sponge or the like having a surface polishing effect before the coating of the coating composition 10.

### Other Method

Examples of the method for coating the coating composition 10 of the present invention other than spray include gravure coating, die coating, spin coating, blade coating, roll coating, slit coating, printing, and dip coating. The coating method is not particularly limited to manufacturing of a member with a complex three-dimensional shape such as an uneven surface, as long as a sustained antibacterial/antiviral effect of the coating composition 10 of the present invention can be achieved.

### EXAMPLES

The present invention will now be specifically described by Examples. The present invention can be modified as appropriate without departing from the gist of the present invention, and Examples described below are not intended to limit the present invention thereto.

### Evaluation of Antibacterial/Antiviral Properties and Persistence

### Antibacterial/Antiviral Properties Against Mold

Antibacterial/antiviral properties against mold were evaluated with reference to JIS Z 2911 Mold resistance test.

A coating composition was applied to a 50 mm square PET film (thickness: 0.1 mm) by a spray method to produce a test piece. A suspension containing mold spores was prepared, and the test piece was placed on an inorganic salt agar medium containing 3% glucose such that the surface to which the coating composition was applied was the top surface, and 0.1 mL of the mixed spore suspension was inoculated over the whole surfaces of the sample and medium. After the inoculation, the medium was cultured at 29±1° C. and a relative humidity of 95% or more for 4 weeks, and the sample surface after the culturing was then observed visually or with a microscope. The growth status of the mold was evaluated on a 5-point scale from 0 to 4. Overview of the growth status of the evaluation criteria is shown below. When the growth status was 0 or 1, it was judged that the anti-mold performance, i.e., antibacterial/antiviral properties were present.

1) Growth status: 0,

No mold was observed by visual evaluation, no mold was observed by evaluation with a microscope, and the area of mold generated on the sample was 0%;

2) Growth status: 1,

No mold was observed by visual evaluation, mold was observed by evaluation with a microscope, and the area of mold generated on the sample was less than 25%;

3) Growth status: 2,

Mold was observed by visual evaluation, mold was observed by evaluation with a microscope, and the area of mold generated on the sample was less than 50%;

4) Growth status: 3,

Mold was observed by visual evaluation, mold was observed by evaluation with a microscope, and the area of mold generated on the sample was 50% or more; and

5) Growth status: 4,

Mold was observed by visual evaluation, mold was observed by evaluation with a microscope, and mold generated on the whole area of the sample.

### Evaluation of Persistence of Antibacterial/Antiviral Properties Against Mold

The evaluation of persistence was determined by whether the antibacterial/antiviral properties were maintained or not even after continued exposure to water. A sample was exposed to water for 7 days and was then subjected to the above-described evaluation of antibacterial/antiviral properties. In the judgment of evaluation, when the growth status was 0, 1, or 2, it was judged that there was anti-mold performance, which was compared to the initial evaluation to judge whether persistence was present or not.

### Evaluation of Antibacterial/Antiviral Properties Against Virus

Antibacterial/antiviral properties against virus were evaluated with reference to ISO 21702 Antiviral activity test.

A coating composition was applied to a 50 mm square glass plate (thickness: 1 mm) by a spray method to produce a test piece. A suspension containing influenza virus was prepared, and 0.1 mL of the influenza virus solution was inoculated onto the surface of the test piece to which the coating composition was applied, and the surface was covered with a 40 mm square PET film piece. Subsequently, the test piece was left at 25±1° C. for 24 hours, and 10 mL of a washing liquid was then added thereto to wash out the virus. The virus infectivity titer (LogPFU/cm²) in the washing liquid was measured by a plaque method.

The antiviral activity value was calculated by the equation below to evaluate the antiviral properties.

R=Ut−At
R: antiviral activity value;
Ut: average of common logarithms of virus infectivity titer (PFU/cm²) after leaving test piece (uncoated product) without application of coating composition for 24 hours; and
At: average of common logarithms of virus infectivity titer (PFU/cm²) after leaving test piece (coated product) with application of coating composition for 24 hours.

When the antiviral activity value was 2 or higher, it was judged that the antiviral properties, i.e., antibacterial/antiviral performance was present.

### Evaluation of Persistence of Antibacterial/Antiviral Properties Against Virus

In the evaluation of persistence of the antibacterial/antiviral properties against virus, the test piece was left in an environment of a temperature of 60° C. and a humidity of 90% for 100 hours, and the antibacterial/antiviral properties against virus were then evaluated. In the judgment of evaluation, the antiviral activity value was evaluated, which was compared to the initial evaluation to judge whether persistence was present or not.

### Evaluation of Hydrophilicity

In evaluation of hydrophilicity, a coating composition was applied to a 50 mm square PET film (thickness: 0.1 mm) by a spray method to form a layer, and the hydrophilicity was evaluated from the contact angle of pure water on the surface to which the coating composition was applied. When the contact angle of pure water at a room temperature of 23° C. and a humidity of 40% to 45% RH was 3° or more and 20° or less, it was judged that there was hydrophilicity. The contact angle was measured using a fully automatic contact angle meter (DM-701, manufactured by Kyowa Interface Science Co., Ltd.) and evaluated.

As the measurement condition, the contact angle 1 second after contact of a droplet of 2 μL of pure water was measured in an environment of 23° C. and 40% RH.

### Evaluation of Porous Property

In order to verify the porous property of a layer obtained from each coating composition, the film thickness and refractive index were evaluated.

The film thickness was determined by measurement and analysis using a spectroscopic ellipsometer (VASE, manufactured by J. A. Woollam Co. Inc.) in a wavelength of from 380 nm to 800 nm. The refractive index was similarly measured using a spectroscopic ellipsometer (VASE, manufactured by J. A. Woollam Co. Inc.) in a wavelength of from 380 nm to 800 nm. The refractive index at a wavelength of 550 nm was defined as the refractive index. The samples for measuring film thickness and refractive index were formed by dropping a coating composition on a synthetic quartz glass substrate with a diameter of 30 mm and a thickness of 1 mm and performing spin coating at a rotation speed of 2000 rpm/20 seconds.

### Evaluation of Film Strength

In order to verify the film strength of a layer obtained from each coating composition, evaluation by a wiping test was implemented.

Evaluation was performed using similar samples to those used for evaluation of the film thickness and refractive index. Silbon paper was moved back and forth on the sample surface 50 times while applying a load of 100, 300, or 500 g/cm² to the sample surface to verify whether the film was peeled off or not by rubbing with a dry cloth. The film strength that is required for the layer 31 varies depending on the type of the antibacterial/antiviral agent used, the usage environment, the application, and so on. For example, in an article using the organic antibacterial/antiviral agent that is intended for use in water section equipment such as a sink and a toilet, it is required that the layer 31 withstands use in environments where the film is exposed to flowing water for a certain period of time (7 days) or more and has repairability that can be peeled off by dusting and cleaning and easily reapplied. In an article that is often touched by a large number of people, the layer 31 is required to have high abrasion resistance. The film strength was evaluated by the following criteria:
A: a film peels off under a load of 100 g/cm²;
B: a film peels off under a load of 300 g/cm²;
C: a film peels off under a load of 500 g/cm²; and
D: a film does not peel off under a load of 500 g/cm².

It is said that a film judged as A has excellent repairability and judged as D has excellent abrasion resistance.

### Evaluation of Dispersion Stability

The dispersion stability of the coating composition was evaluated as follows. As an index for evaluating the dispersion states of a coating composition immediately after its preparation and after one month, the refractive index of the layer formed from each coating composition was evaluated. A decrease in the dispersibility causes aggregation of the component contained in a coating composition and therefore appears as a change in the refractive index.

The dispersion stability was evaluated according to the criteria below. The amount of change in the refractive index represents an absolute value.
A: an amount of change in refractive index is 0.3 or less;
B: an amount of change in refractive index is larger than 0.3 and 0.5 or less; and
C: an amount of change in refractive index is larger than 0.5.

### Production of Coating Composition

### Example 1

To 10 g of 0.1% dilute hydrochloric acid, 30 g of isopropyl alcohol and 12 g of methyl polysilicate (manufactured by Colcoat Co., Ltd., Methyl Silicate 53A) were slowly added, followed by stirring in a room temperature environment for 240 minutes to prepare silica sol (hereinafter, silica sol 1).

Fifty grams of isopropyl alcohol dispersion silica sol (manufactured by Nissan Chemical Corporation, IPA-ST-UP, average particle diameter: about 12 nm, solid content concentration: 15%) of silicon oxide particles were diluted with isopropyl alcohol to a solid content concentration of 5 mass %. Subsequently, silica sol 1 was added thereto such that the mass ratio of silicon oxide particle:silica sol component was 100/10 to prepare a mixture solution of the silicon oxide particles, the inorganic binder component, and the solvent.

Furthermore, 3-methyl-4-isopropylphenol (trade name: Isopropylmethylphenol, manufactured by Osaka Kasei Co., Ltd.) as the organic antibacterial/antiviral agent was added in an amount of 0.5 wt % based on the total amount of the coating composition, followed by mixing and stirring at room temperature for 2 hours to obtain a coating composition 1. The various evaluations described above were performed using the obtained coating composition 1.

### Example 2

A mixture solution of a silicon oxide particle, an inorganic binder component, and a solvent was prepared as in Example 1 except that the silica sol 1 was added so that the ratio of silicon oxide particle:silica sol component was 100/10.

Furthermore, 3-methyl-6-isopropylphenol (trade name: Marcarep RM, manufactured by Osaka Kasei Co., Ltd.) as the organic antibacterial/antiviral agent was added in an amount of 1.0 wt % based on the total amount of the coating composition, followed by mixing and stirring at room temperature for 2 hours to obtain a coating composition 2. The various evaluations described above were performed using the obtained coating composition 2.

### Example 3

A mixture solution of a silicon oxide particle, an inorganic binder component, and a solvent was prepared as in Example 1 except that the silica sol 1 was added so that the ratio of silicon oxide particle:silica sol component was 100/15.

Furthermore, butyl paraoxybenzoate (trade name: Mekkins-B, manufactured by Ueno Fine Chemicals Industry, Ltd.) as the organic antibacterial/antiviral agent was added in an amount of 1.0 wt % based on the total amount of the coating composition, followed by mixing and stirring at room temperature for 2 hours to obtain a coating composition 3. The various evaluations described above were performed using the obtained coating composition 3.

### Example 4

A mixture solution of a silicon oxide particle, an inorganic binder component, and a solvent was prepared as in Example 1 except that the silica sol 1 was added so that the ratio of silicon oxide particle:silica sol component was 100/25.

Furthermore, 3-methyl-6-isopropylphenol which was the same organic antibacterial/antiviral agent as in Example 2 was added in an amount of 2.0 wt % based on the total amount of the coating composition, followed by mixing and stirring at room temperature for 2 hours to obtain a coating composition 4. The various evaluations described above were performed using the obtained coating composition 4.

### Example 5

Fifty grams of isopropyl alcohol dispersion silica sol (manufactured by Fuso Chemical Co., Ltd., PL-1-IPA, average particle diameter: about 15 nm, solid content concentration: 12.5%) of hydrophilic silicon oxide particles were diluted with isopropyl alcohol to a solid content concentration of 5 mass %, and the silica sol 1 was added thereto such that the ratio of silicon oxide particle:silica sol component was 100/10.

Furthermore, an organic halide (trade name: Marukataquinone KD-29, manufactured by Osaka Kasei Co., Ltd.) as the organic antibacterial/antiviral agent was added in an amount of 1.0 wt % based on the total amount of the coating composition, followed by mixing and stirring at room temperature for 2 hours to obtain a coating composition 5. The various evaluations described above were performed using the obtained coating composition 5.

### Example 6

To 10 g of 0.1% dilute hydrochloric acid, 30 g of isopropyl alcohol and 10 g of an oligomer of ethyl silicate (manufactured by Colcoat Co., Ltd., Ethyl Silicate 40, average pentamer) were slowly added, followed by stirring in a room temperature environment for 240 minutes to prepare silica sol (hereinafter, silica sol 2).

Fifty grams of isopropyl alcohol dispersion silica sol (manufactured by Nissan Chemical Corporation, IPA-ST-UP, average particle diameter: about 12 nm, solid content concentration: 15%) of hydrophilic silicon oxide particles were diluted with isopropyl alcohol to a solid content concentration of 5 mass %, and the silica sol 2 was added thereto such that the ratio of silicon oxide particle:silica sol component was 100/15.

Furthermore, 3-methyl-4-isopropylphenol (trade name: Isopropyl methyl phenol, manufactured by Osaka Kasei Co., Ltd.) as the organic antibacterial/antiviral agent was added in an amount of 4.0 wt % based on the total amount of the coating composition, followed by mixing and stirring at room temperature for 2 hours to obtain a coating composition 6. The various evaluations described above were performed using the obtained coating composition 6.

### Example 7

A mixture solution of a silicon oxide particle, an inorganic binder component, and a solvent was prepared as in Example 6 except that the silica sol 2 was added so that the ratio of silicon oxide particle:silica sol component was 100/20.

Furthermore, thiabendazole (trade name: Marukaside M101, manufactured by Osaka Kasei Co., Ltd.) as the organic antibacterial/antiviral agent was added in an amount of 1.0 wt % based on the total amount of the coating composition, followed by mixing and stirring at room temperature for 2 hours to obtain a coating composition 7. The various evaluations described above were performed using the obtained coating composition 7.

### Example 8

A mixture solution of a silicon oxide particle, an inorganic binder component, and a solvent was prepared as in Example 6 except that the silica sol 2 was added so that the ratio of silicon oxide particle:silica sol component was 100/5.

Furthermore, butyl paraoxybenzoate (trade name: Mekkins-B, manufactured by Ueno Fine Chemicals Industry, Ltd.) as the organic antibacterial/antiviral agent was added in an amount of 1.0 wt % based on the total amount of the coating composition, followed by mixing and stirring at room temperature for 2 hours to obtain a coating composition 8. The various evaluations described above were performed using the obtained coating composition 8.

### Example 9

A mixture solution of a silicon oxide particle, an inorganic binder component, and a solvent was prepared as in Example 1.

Furthermore, an organic nitrogen compound (trade name: Marukaside TB, manufactured by Osaka Kasei Co., Ltd.) as the organic antibacterial/antiviral agent was added in an amount of 0.5 wt % based on the total amount of the coating composition, followed by mixing and stirring at room temperature for 2 hours to obtain a coating composition 9. The various evaluations described above were performed using the obtained coating composition 9.

### Example 10

A mixture solution of a silicon oxide particle, an inorganic binder component, and a solvent was prepared as in Example 1 except that isopropyl alcohol dispersion silica sol of silicon oxide particles was diluted to a solid content concentration of 10 mass % and the ratio of silicon oxide particle:silica sol component was 100/5.

Furthermore, butyl paraoxybenzoate (trade name: Mekkins P, manufactured by Ueno Fine Chemicals Industry, Ltd.) as the organic antibacterial/antiviral agent was added in an amount of 10.0 wt % based on the total amount of the coating composition. Furthermore, a quaternary ammonium salt (cationic surfactant) was added in an amount of 0.1 wt % based on the total amount of the coating composition, followed by mixing and stirring at room temperature for 2 hours to obtain a coating composition 10. The various evaluations described above were performed using the obtained coating composition 10.

### Example 11

Fifty grams of isopropyl alcohol dispersion silica sol (manufactured by Nissan Chemical Corporation, IPA-ST-UP, average particle diameter: 12 nm, solid content concentration: 15%) of hydrophilic silicon oxide particles were diluted with isopropyl alcohol to a solid content concentration of 0.5 mass %. Silica sol 1 was added thereto such that the mass ratio of silicon oxide particle:silica sol component was 100/2.5 to prepare a mixture solution of the silicon oxide particles, the inorganic binder component, and the solvent.

Furthermore, 1,2-benzisothiazol-3(2H)-one (trade name: 1,2-Benzisothiazol-3(2H)-one, manufactured by Tokyo Chemical Industry Co., Ltd.) as the organic antibacterial/antiviral agent was added in an amount of 0.2 wt % based on the total amount of the coating composition, followed by mixing and stirring at room temperature for 2 hours to obtain a coating composition 11. The various evaluations described above were performed using the obtained coating composition 11.

### Example 12

A mixture solution of a silicon oxide particle, an inorganic binder component, and a solvent was prepared as in Example 11 except that the silica sol 1 was added so that the ratio of silicon oxide particle:silica sol component was 100/10.

Furthermore, 3-iodo-2-propynyl N-butylcarbamate (trade name: 3-Iodo-2-propynyl N-Butylcarbamate, manufactured by Tokyo Chemical Industry Co., Ltd.) as the organic antibacterial/antiviral agent was added in an amount of 0.1 wt % based on the total amount of the coating composition, followed by mixing and stirring at room temperature for 2 hours to obtain a coating composition 12. The various evaluations described above were performed using the obtained coating composition 12.

### Comparative Example 1

A mixture solution of a silicon oxide particle, a binder, and a solvent was prepared as in Example 5 except that the silica sol 1 was added so that the ratio of silicon oxide particle:silica sol component was 100/15 to obtain a coating composition 17. The coating composition 17 did not contain an antibacterial/antiviral agent.

The various evaluations described above were performed using the obtained coating composition 17.

### Comparative Example 2

Fifty grams of isopropyl alcohol dispersion silica sol (manufactured by Fuso Chemical Co., Ltd. PL-1-IPA, average particle diameter: about 15 nm, solid content concentration: 12.5%) of silicon oxide particles were diluted with isopropyl alcohol to a solid content concentration of 5 mass %. Subsequently, the silica sol 2 was added so that the ratio of silicon oxide particle:silica sol component was 100/30.

Furthermore, butyl paraoxybenzoate (trade name: Mekkins P, manufactured by Ueno Fine Chemicals Industry, Ltd.) as the organic antibacterial/antiviral agent was added in an amount of 1.0 wt % based on the total amount of the coating composition, followed by mixing and stirring at room temperature for 2 hours to obtain a coating composition 14. The various evaluations described above were performed using the obtained coating composition 14.

Comparative Example 3

Ten grams of silicone resin was slowly added to 30 g of isopropanol, followed by stirring in a room temperature environment for 240 minutes to prepare a silicone resin dilution solution.

Fifty grams of isopropyl alcohol dispersion silica sol (manufactured by Nissan Chemical Corporation, IPA-ST-UP, average particle diameter: 12 nm, solid content concentration: 15%) of silicon oxide particles were diluted with isopropyl alcohol to a solid content concentration of 5 mass %. Subsequently, a silicone resin dilution solution was added so that the mass ratio of silicon oxide particle:silicone resin was 100/10.

Furthermore, thiabendazole (trade name: Marukaside M101, manufactured by Osaka Kasei Co., Ltd.) as the organic antibacterial/antiviral agent was added in an amount of 0.5 wt % based on the total amount of the coating composition, followed by mixing and stirring at room temperature for 2 hours to obtain coating composition 18. Various evaluations described above were performed using the obtained coating composition 18.

### Comparative Example 4

Fifty grams of isopropyl alcohol dispersion silica sol (manufactured by Nissan Chemical Corporation, IPA-ST-UP, average particle diameter: about 12 nm, solid content concentration: 15%) of hydrophilic silicon oxide particles were diluted with isopropyl alcohol to a solid content concentration of 0.5 mass %. Subsequently, the silica sol 2 was added so that the mass ratio of silicon oxide particle:silica sol component was 100/0.5 to prepare a mixture solution of the silicon oxide particles, the inorganic binder component, and the solvent.

Mixing and stirring were performed at room temperature for 2 hours to obtain a coating composition 19. The coating composition 19 did not contain an antibacterial/antiviral agent.

### Comparative Example 5

Fifty grams of isopropyl alcohol dispersion silica sol (manufactured by Nissan Chemical Corporation, IPA-ST-UP, average particle diameter: about 12 nm, solid content concentration: 15%) of silicon oxide particles were diluted with isopropyl alcohol to a solid content concentration of 10 mass %. Subsequently, the silica sol 1 was added so that the mass ratio of silicon oxide particle:silica sol component was 100/10 to prepare a mixture solution of the silicon oxide particles, the inorganic binder component, and the solvent.

A mixture solution of a silicon oxide particle, an inorganic binder component, and a solvent was prepared as in Example 1 except that the organic antibacterial/antiviral agent was added in an amount of 30 wt % based on the total amount of the coating composition to prepare a coating composition 20.

Coating compositions of Examples of 1 to 12 and Comparative Examples 1 to 5 were produced by the above-described method. Regarding Examples 2 and 11, antibacterial/antiviral properties against mold and influenza virus and film strength were evaluated. Regarding Examples 1, 3 to 10, and 12 and Comparative Examples 1 to 4, antibacterial/antiviral properties against mold and film strength were evaluated. Regarding Comparative Example 5, antibacterial/antiviral properties against influenza virus and film strength were evaluated. The evaluations of dispersion stability, hydrophilicity, contact angle, refractive index, and film thickness were performed by comparing all Examples and Comparative Examples.

TABLE 1

| | Coating composition | | | | | | | | |
|---|---|---|---|---|---|---|---|---|---|
| | | Binder | | | | | | | |
| | | | Amount added | Antibacterial agent | | | | | |
| | Silicon | | relative to 100 parts | | | Content of | Content relative | | |
| | oxide | | by mass of silicon | | | coating | to total solid | | Dispersion |
| | particle | | oxide particle | | | composition | content | Solvent | stability |
| | Type | Type | [part by mass] | Type | | [wt %] | [wt %] | Type | evaluation |
| Example 1 | Chain- | Methyl | 10 | Organic | 3-Methyl-4- | 0.5 | 8.3 | IPA | A |
| | like | polysilicate | | system | isopropylphenol | | | | |
| Example 2 | Chain- | Methyl | 10 | Organic | 3-Mehtyl-6- | 1.0 | 15.4 | IPA | A |
| | like | polysilicate | | system | isopropylphenol | | | | |
| Example 3 | Chain- | Methyl | 15 | Organic | Butyl | 1.0 | 14.8 | IPA | B |
| | like | polysilicate | | system | paraoxybenzoate | | | | |
| Example 4 | Chain- | Methyl | 25 | Organic | 3-Mehtyl-6- | 2.0 | 24.2 | IPA | B |
| | like | polysilicate | | system | isopropylphenol | | | | |
| Example 5 | Cocoon- | Methyl | 10 | Organic | Organic halide | 1.0 | 15.4 | IPA | A |
| | shaped | polysilicate | | system | | | | | |
| Example 6 | Chain- | Ethyl | 15 | Organic | 3-Methyl-4- | 2.0 | 25.8 | IPA | B |
| | like | silicate | | system | isopropylphenol | | | | |
| | | oligomer | | | | | | | |
| Example 7 | Chain- | Ethyl | 20 | Organic | Thiabendazole | 1.0 | 14.3 | IPA | B |
| | like | silicate | | system | | | | | |
| | | oligomer | | | | | | | |
| Example 8 | Chain- | Ethyl | 1 | Organic | Butyl | 1.0 | 16.5 | IPA | A |
| | like | silicate | | system | paraoxybenzoate | | | | |
| | | oligomer | | | | | | | |
| Example 9 | Chain- | Methyl | 10 | Organic | Organic nitrogen | 0.5 | 8.3 | IPA | B |
| | like | polysilicate | | system | compound | | | | |
| Example 10 | Chain- | Methyl | 5 | Organic | Butyl | 4.0 | 27.6 | IPA | A |
| | like | polysilicate | | system | paraoxybenzoate | | | | |
| Example 11 | Chain- | Methyl | 3 | Organic | 1,2- | 0.2 | 28.0 | IPA | A |
| | like | polysilicate | | system | Benzisothiazol- | | | | |
| | | | | | 3(2H)-one | | | | |
| Example 12 | Chain- | Methyl | 10 | Organic | 3-lodo-2-propynyl | 0.1 | 15.4 | IPA | A |
| | like | polysilicate | | system | N-butylcarbamate | | | | |
| Comparative | Cocoon- | Methyl | 15 | | — | — | — | IPA | A |
| Example 1 | shaped | polysilicate | | | | | | | |
| Comparative | Cocoon- | Ethyl | 30 | Organic | Buty | 1.0 | 13.3 | IPA | A |
| Example 2 | shaped | silicate | | system | paraoxybenzoate | | | | |
| | | oligomer | | | | | | | |
| Comparative | Chain- | Silicone | 10 | Organic | Thiabendazole | 0.5 | 8.3 | IPA | B |
| Example 3 | like | resin | | system | | | | | |
| Comparative | Chain- | Ethyl | 0.5 | — | — | — | — | IPA | A |
| Example 4 | like | silicate | | | | | | | |
| | | oligomer | | | | | | | |
| Comparative | Chain- | Ethyl | 10 | Organic | 3-Methyl-4- | 30 | 73.2 | IPA | C |
| Example 5 | like | silicate | | system | isopropylphenol | | | | |
| | | oligomer | | | | | | | |

| | Evaluation of film | | | | | | | |
|---|---|---|---|---|---|---|---|---|
| | Antibacterial/antiviral property | | | | | | | |
| | Mold | | Virus | | | | | |
| | | 7 | | 100 | Contact | Refractive | Film | |
| | | days | | hours | angle | index | thickness | Film |
| | Beginning | later | Beginning | later | [degree] | λ550 nm | [nm] | strength |
| Example 1 | 0 | 0 | — | — | 9.2 | 1.234 | 326 | B |
| Example 2 | 0 | 0 | 2.7 | 2.2 | 7.6 | 1.220 | 345 | B |
| Example 3 | 0 | 1 | — | — | 10.5 | 1.253 | 371 | B |
| Example 4 | 0 | 2 | — | — | 7.7 | 1.185 | 392 | C |
| Example 5 | 1 | 1 | — | — | 10.9 | 1.243 | 355 | B |
| Example 6 | 1 | 2 | — | — | 12.4 | 1.171 | 423 | A |
| Example 7 | 1 | 2 | — | — | 9.7 | 1.238 | 340 | B |
| Example 8 | 1 | 1 | — | — | 17.9 | 1.263 | 491 | A |
| Example 9 | 0 | 2 | — | — | 13.2 | 1.232 | 322 | B |
| Example 10 | 1 | 0 | — | — | 7.2 | 1.216 | 513 | B |
| Example 11 | 0 | 0 | 3.2 | 2.1 | 7.5 | 1.047 | 44 | A |
| Example 12 | 0 | 0 | — | — | 6.9 | 1.103 | 149 | A |
| Comparative | 3 | 4 | — | — | 10.8 | 1.206 | 372 | B |
| Example 1 | | | | | | | | |
| Comparative | 3 | 3 | — | — | 7.8 | 1.337 | 368 | D |
| Example 2 | | | | | | | | |
| Comparative | 2 | 3 | — | — | 106.4 | 1.434 | 326 | C |
| Example 3 | | | | | | | | |
| Comparative | 3 | 4 | — | — | 25.8 | 1.026 | 19 | A |
| Example 4 | | | | | | | | |
| Comparative | 0 | 3 | — | — | 45.2 | 1.385 | 652 | A |
| Example 5 | | | | | | | | |

As shown in the evaluation results of Examples 1 to 12 in Table 1, it was demonstrated that films obtained from the coating composition according to the present invention had excellent antibacterial/antiviral properties. It was confirmed that in the configurations of Examples 1 to 12, antibacterial/antiviral properties can be maintained even after exposure to water. Furthermore, since the contact angle to water is low and the hydrophilicity is also high, the antifouling property is also excellent. According, a high antifouling property and antibacterial/antiviral properties are obtained in applications, such as water section equipment, that are frequently exposed to water.

In addition, the film was confirmed to have high abrasion resistance not to be damaged by being touched. Furthermore, since the contact angle to water is low and the hydrophilicity is also high, the antifouling property is also excellent. Accordingly, in applications to articles that are touched by people, such as product exterior coating, high antifouling property and antibacterial/antiviral properties are obtained.

The disclosure of the above embodiments include the following aspects.

### Aspect 1

A coating composition comprising an inorganic compound particle, a binder component, a solvent, and an antibacterial/antiviral agent, wherein a content of the binder component is 1 part by mass or more and 25 parts by mass or less based on 100 parts by mass of the inorganic compound particle.

### Aspect 2

The coating composition according to aspect 1, wherein the antibacterial/antiviral agent is a benzisothiazoline compound or a carbamic acid ester derivative.

### Aspect 3

The coating composition according to aspect 1, wherein the antibacterial/antiviral agent includes at least one selected from the group consisting of copper, silver, zinc, nickel, and compounds thereof.

### Aspect 4

The coating composition according to any one of aspects 1 to 3, wherein a content of the antibacterial/antiviral agent is 1 part by mass or more and 30 parts by mass or less based on 100 parts by mass of the total solid content of the coating composition.

### Aspect 5

The coating composition according to any one of aspects 1 to 3, wherein a content of the antibacterial/antiviral agent is 0.0001 parts by mass or more and 20 parts by mass or less based on 100 parts by mass of the total solid content of the coating composition.

### Aspect 6

The coating composition according to any one of aspects 1 to 5, wherein a content of the inorganic compound particle is 2 parts by mass or more and 10 parts by mass or less based on 100 parts by mass of the total solid content of the coating composition.

### Aspect 7

The coating composition according to any one of aspects 1 to 6, wherein the inorganic compound particle is a silicon oxide particle.

### Aspect 8

The coating composition according to any one of aspects 1 to 7, wherein the inorganic compound particle is a chain-shaped particle.

### Aspect 9

The coating composition according to any one of aspects 1 to 8, wherein the inorganic compound particle has an average particle diameter of 10 nm or more and 1000 nm or less.

### Aspect 10

The coating composition according to any one of aspects 1 to 9, wherein the binder component is a silicon oxide oligomer.

### Aspect 11

The coating composition according to any one of aspects 1 to 10, wherein the solvent includes at least one selected from the group consisting of ethoxyethanol, propoxyethanol, isopropoxyethanol, butoxyethanol, 1-methoxy-2-propanol, 1-ethoxy-2-propanol, 1-propoxy-2-propanol, and ethyl lactate.

### Aspect 12

The coating composition according to any one of aspects 1 to 11, further comprising an acid and having a pH of 2 or more and 8 or less.

### Aspect 13

A spray coating material comprising a material storage part and an ejection part, wherein the material storage part is filled with the coating composition according to any one of aspects 1 to 12.

### Aspect 14

An article comprising a base material and a porous layer on at least one main surface of the base material, wherein
the porous layer contains a plurality of inorganic compound particles bound to each other by a binder and an antibacterial/antiviral agent.

### Aspect 15

The article according to aspect 14, wherein the antibacterial/antiviral agent is a benzisothiazoline compound or a carbamic acid ester derivative.

### Aspect 16

The article according to aspect 14, wherein the antibacterial/antiviral agent includes at least one selected from the group consisting of copper, silver, zinc, nickel, and compounds thereof.

### Aspect 17

The article according to any one of aspects 14 to 16, wherein a content of the antibacterial/antiviral agent is 1 mass % or more and 30 mass % or less.

### Aspect 18

The article according to any one of aspects 14 to 17, wherein the inorganic compound particle is a silicon oxide particle.

### Aspect 19

The article according to any one of aspects 14 to 18, wherein the inorganic compound particle has an average particle diameter of 10 nm or more and 1000 nm or less.

### Aspect 20

The article according to any one of aspects 14 to 19, having a film thickness of 0.02 μm or more and 10 μm or less.

According to the present invention, it is possible to provide a coating composition that can provide a layer that can maintain antibacterial/antiviral action over a long period of time and an article having a layer made of the coating composition.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

### INDUSTRIAL APPLICABILITY

The coating composition of the present invention can be applied to water section equipment such as a toilet, a bath, and a washstand, around an air conditioner, window glass, a car body and undercarriage, an interior building material, and also an underwater drone window used in seawater environment, and so on. Furthermore, the coating composition can also be applied to product exterior coating, a touch panel display, a doorknob, a hanging strap, a handrail, a panel, and an interior material.

The present invention is not limited to the above embodiments, and various changes and modifications can be made without departing from the spirit and scope of the present invention. Accordingly, the following claims are appended to disclose the scope of the present invention.

1. A coating composition comprising an inorganic compound particle, a binder component, a solvent, and an antibacterial/antiviral agent, wherein a content of the binder component is 1 part by mass or more and 25 parts by mass or less based on 100 parts by mass of the inorganic compound particle.

2. The coating composition according to claim 1, wherein the antibacterial/antiviral agent is a benzisothiazoline compound or a carbamic acid ester derivative.

3. The coating composition according to claim 1, wherein the antibacterial/antiviral agent includes at least one selected from the group consisting of copper, silver, zinc, nickel, and compounds thereof.

4. The coating composition according to claim 1, wherein a content of the antibacterial/antiviral agent is 1 part by mass or more and 30 parts by mass or less based on 100 parts by mass of the total solid content of the coating composition.

5. The coating composition according to claim 1, wherein a content of the antibacterial/antiviral agent is 0.0001 parts by mass or more and 20 parts by mass or less based on 100 parts by mass of the total solid content of the coating composition.

6. The coating composition according to claim 1, wherein a content of the inorganic compound particle is 2 parts by mass or more and 10 parts by mass or less based on 100 parts by mass of the total solid content of the coating composition.

7. The coating composition according to claim 1, wherein the inorganic compound particle is a silicon oxide particle.

8. The coating composition according to claim 1, wherein the inorganic compound particle is a chain-shaped particle.

9. The coating composition according to claims 1, wherein the inorganic compound particle has an average particle diameter of 10 nm or more and 1000 nm or less.

10. The coating composition according to claim 1, wherein the binder component is a silicon oxide oligomer.

11. The coating composition according to claim 1, wherein the solvent includes at least one selected from the group consisting of ethoxyethanol, propoxyethanol, isopropoxyethanol, butoxyethanol, 1-methoxy-2-propanol, 1-ethoxy-2-propanol, 1-propoxy-2-propanol, and ethyl lactate.

12. The coating composition according to claim 1, further comprising an acid and having a pH of 2 or more and 8 or less.

13. A spray coating material comprising a material storage part and an ejection part, wherein the material storage part is filled with the coating composition according to claim 1.

14. An article comprising a base material and a porous layer on at least one main surface of the base material, wherein the porous layer contains a plurality of inorganic compound particles bound to each other by a binder and an antibacterial/antiviral agent.

15. The article according to claim 14, wherein the antibacterial/antiviral agent is a benzisothiazoline compound or a carbamic acid ester derivative.

16. The article according to claim 14, wherein the antibacterial/antiviral agent includes at least one selected from the group consisting of copper, silver, zinc, nickel, and compounds thereof.

17. The article according to claim 14, wherein a content of the antibacterial/antiviral agent is 1 mass % or more and 30 mass % or less.

18. The article according to claim 14, wherein the inorganic compound particle is a silicon oxide particle.

19. The article according to claim 14, wherein the inorganic compound particle has an average particle diameter of 10 nm or more and 1000 nm or less.

20. The article according to claim 14, having a film thickness of 0.02 μm or more and 10 μm or less.
